(19) United States
(12) Patent Application Publication
(10) Pub. No.: US 2007/0113797 A1
(43) Pub. Date: May 24, 2007

(54) Electrical pet gate

(75) Inventors: Christopher E. Mainini, Knoxville, TN (US); Steven L. Lawrence, Johnson City, TN (US); Terry G. Carpenter, Knoxville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/284,278

(22) Filed: Nov. 21, 2005

(51) Int. Cl. A01K 15/04; A01K 3/00

(52) U.S. Cl. 119/721

(57) ABSTRACT

Described is a pet gate device for generating a non-tangible electrical pet barrier and for generating a non-tangible electrical pet passageway. The pet gate device includes a signal generating device and a receiver. The signal generating device is adapted to generate at least two different signals, namely a barrier signal and a passageway signal. The signal generating device includes a transmitter for transmitting the generated signals. The receiver is adapted to receive the transmitted signals and to recognize whether the barrier signal or the passageway signal is being generated and transmitted. The receiver is adapted to administer a stimulus to the pet when the receiver recognizes the barrier signal. Conversely, the receiver is adapted to not administer a stimulus to the pet when the receiver recognizes a passageway signal.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a device for generating a non-tangible electrical pet gate. More particularly, this invention pertains to a device for generating a non-tangible electrical pet barrier and a non-tangible electrical pet passageway.

2. Description of the Related Art

Oftentimes, there is a need to restrict a pet's access to or from a particular room or to restrict a pet's access to a small particular area. For example, a pet owner may wish to prevent the pet from entering the pet owner's bedroom, or the pet owner may wish to confine the pet to the laundry room of the pet owner's home, or the pet owner may wish to prevent the pet from tampering with the pet owner's kitchen trashcan. Additionally, pet owners seek to limit a pet's access without using tangible barriers, which not only restrict the pet's access to or from designated areas, but also hinder human access to or from those areas. In addition to restricting a pet's access to rooms and small particular areas, a pet owner commonly needs to prevent the pet from leaving the confines of the pet owner's yard. To confine a pet within the pet owner's yard, it is common for the pet owner to implement a conventional invisible pet containment system that corrects the pet by way of a stimulus when the pet approaches the perimeter of the yard, which is defined by the invisible pet containment system. However, certain circumstances require that the pet be able to approach and pass across the perimeter of an invisible pet containment system at a designated region without receiving a stimulus such that the pet has access to other permitted areas, such as the pet owner's home. Because of these circumstances, a pet owner needs the facility to permit the pet passage across the perimeter of an invisible pet containment system without being required to manually disengage the entire system.

Conventional devices that address the previously discussed issues of pet confinement and access include pet repelling mats and pet repelling devices. A pet repelling mat is a type of floor mat that emits an electromagnetic field. A pet carries a receiver that is responsive to the electromagnetic field such that when the pet approaches the mat, the pet receives a stimulus from the receiver. The pet repelling mat is positioned, for example, in the doorway of a room or under the kitchen trashcan such that when the pet approaches the doorway or the trashcan, the pet receives a stimulus. While this type of conventional device can prevent access to or from a particular room and even prevent access to a small particular area, the device is limited in that it does not permit a pet passage to and from the confines of a conventional invisible fence containment system.

A pet repelling device suffers the same limitations as the pet repelling mat. A pet repelling device is a packaging or housing that emits an electromagnetic field. A pet carries a receiver that is responsive to the electromagnetic field such that when the pet approaches the device, the pet receives a stimulus from the receiver. The pet repelling device is positioned in areas that are not to be accessed by the pet. Consequently, when the pet approaches the restricted area, the pet receives a stimulus. Similar to the pet repelling mat, this type of conventional device can prevent access to or from a particular room and even prevent access to a small particular area, however, the device is limited in that it does not permit a pet passage to and from the confines of a conventional invisible fence containment system.

### BRIEF SUMMARY OF THE INVENTION

In accordance with the various features of the present invention there is provided a pet gate device for generating a non-tangible electrical pet barrier and for generating a non-tangible electrical pet passageway. The pet gate device includes a signal generating device and a receiver. The signal generating device is adapted to generate at least two different signals, namely a barrier signal and a passageway signal. At a given time, the signal generating device generates only one signal, the barrier signal or the passageway signal. The signal generating device includes a transmitter for transmitting the currently generated signal such that the transmitted signal generates an electromagnetic field. The receiver is adapted to respond to the electromagnetic field by receiving the transmitted signal and recognizing whether the barrier signal or the passageway signal is being generated and transmitted. The receiver is also adapted to respond to and recognize a signal generated by a conventional invisible pet containment system (conventional signal). The receiver is carried by a pet and is adapted to administer a stimulus to the pet when the receiver recognizes the barrier signal or the conventional signal. The receiver is adapted to not administer a stimulus to the pet when the receiver recognizes the passageway signal. Further, the passageway signal overrides a stimulus-causing signal, such as the barrier signal or the conventional signal, such that when the receiver concurrently receives both the passageway signal and a stimulus-causing signal, the receiver does not administer a stimulus to the pet. Consequently, when the pet approaches the signal generating device to the extent that the receiver responds to the electromagnetic field and recognizes that the signal generating device is generating and transmitting the barrier signal, the receiver administers a stimulus to the pet. Accordingly, when disposed proximate to the doorway of a room, the signal generating device creates a non-tangible electrical barrier and restricts the pet's access to or from the room. Conversely, when the pet approaches the signal generating device to the extent that the receiver responds to the electromagnetic field and recognizes that the signal generating device is generating and transmitting the passageway signal, the receiver does not administer a stimulus to the pet, even when the receiver concurrently receives and recognizes another signal that indicates the administration of a stimulus, such as the conventional signal. Accordingly, when the signal generating device is disposed proximate to the perimeter of a conventional invisible pet containment system, the signal generating device creates a non-tangible electrical passageway through the containment system.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an illustration of the pet gate device in accordance with various features of the present invention.

FIG. 2 is a diagram depicting strategically positioned signal generating devices of the pet gate device of FIG. 1 illustrating operative features of the signal generating devices.

FIG. 3 is a timing diagram illustrating operative features of the receiver of the pet gate device of FIG. 1.

### DETAILED DESCRIPTION OF THE INVENTION

One embodiment of a pet gate device for generating a non-tangible electrical pet barrier and for generating a non-tangible electrical pet passageway and constructed in accordance with the various features of the present invention is illustrated generally at 10 in FIG. 1. The pet gate device 10 includes a signal generating device and a receiver. The signal generating device is adapted to generate at least two different signals, namely a barrier signal and a passageway signal. At a given time, the signal generating device generates only one signal, the barrier signal or the passageway signal. The signal generating device includes a transmitter for transmitting the currently generated signal such that the transmitted signal generates an electromagnetic field. The receiver is adapted to respond to the electromagnetic field by receiving the transmitted signal and recognizing whether the barrier signal or the passageway signal is being generated and transmitted. The receiver is also adapted to respond to and recognize a signal generated by a conventional invisible pet containment system (conventional signal). The receiver is carried by a pet and is adapted to administer a stimulus to the pet when the receiver recognizes the barrier signal or the conventional signal. The receiver is adapted to not administer a stimulus to the pet when the receiver recognizes the passageway signal. Further, the passageway signal overrides a stimulus-causing signal, such as the barrier signal or the conventional signal, such that when the receiver concurrently receives both the passageway signal and a stimulus-causing signal, the receiver does not administer a stimulus to the pet. Consequently, when the pet approaches the signal generating device to the extent that the receiver responds to the electromagnetic field and recognizes that the signal generating device is generating and transmitting the barrier signal, the receiver administers a stimulus to the pet. Accordingly, when disposed proximate to the doorway of a room, the signal generating device creates a non-tangible electrical barrier and restricts the pet's access to or from the room. Conversely, when the pet approaches the signal generating device to the extent that the receiver responds to the electromagnetic field and recognizes that the signal generating device is generating and transmitting the passageway signal, the receiver does not administer a stimulus to the pet, even when the receiver concurrently receives and recognizes another signal that indicates the administration of a stimulus, such as the conventional signal. Accordingly, when the signal generating device is disposed proximate to the perimeter of a conventional invisible pet containment system, the signal generating device creates a non-tangible electrical passageway through the containment system.

FIG. 1 illustrates the pet gate device 10 in accordance with various features of the present invention. The pet gate device 10 includes a signal generating device 12 and a receiver 14. At a given time, the signal generating device 12 generates either a barrier signal or a passageway signal. Whether the signal generating device 12 generates the barrier signal or the passageway signal is dictated by the pet gate device user, who selects the desired signal by way of a user interface 16, which is disposed on the signal generating device 12. The signal generating device 12 includes a transmitter that transmits the currently generated signal, namely the barrier signal or the passageway signal, such that the transmitted signal generates an electromagnetic field 13 that radiates from the signal generating device 12.

The receiver 14 is carried by a pet. In the illustrated embodiment, the receiver 14 is mounted to the pet by way of a conventional pet collar. The receiver 14 is adapted to respond to the electromagnetic field 13 by receiving the transmitted signal and to recognize whether the barrier signal or the passageway signal is being generated and transmitted by signal generating device 12. The receiver 14 is also adapted to respond to the electromagnetic field generated by a conventional invisible pet containment system (conventional electromagnetic field) and to recognize that a conventional signal is being generated and transmitted. The receiver 14 is adapted to administer a stimulus to the pet when the receiver 14 responds to the electromagnetic field 13 and recognizes that the barrier signal is being generated and transmitted. The receiver 14 also administers a stimulus to the pet when the receiver 14 responds to the conventional electromagnetic field and recognizes that the conventional signal is being generated and transmitted. Conversely, the receiver 14 is adapted to not administer a stimulus to the pet when the receiver 14 responds to the electromagnetic field 13 and recognizes that the passageway signal is being generated and transmitted, even if the receiver 14 simultaneously receives and recognizes the barrier signal or the conventional signal. In other words, the passageway signal overrides a stimulus-causing signal.

Those skilled in the art will recognize that the signal generating device 12 can generate signals in addition to the barrier signal and the passageway signal without departing from the scope or spirit of the present invention. For example, the signal generating device 12 can generate and transmit a warning signal such that when the receiver 14 responds to the electromagnetic field 13 and recognizes the warning signal, the receiver 14 administers a warning stimulus, which is milder than the typical stimulus.

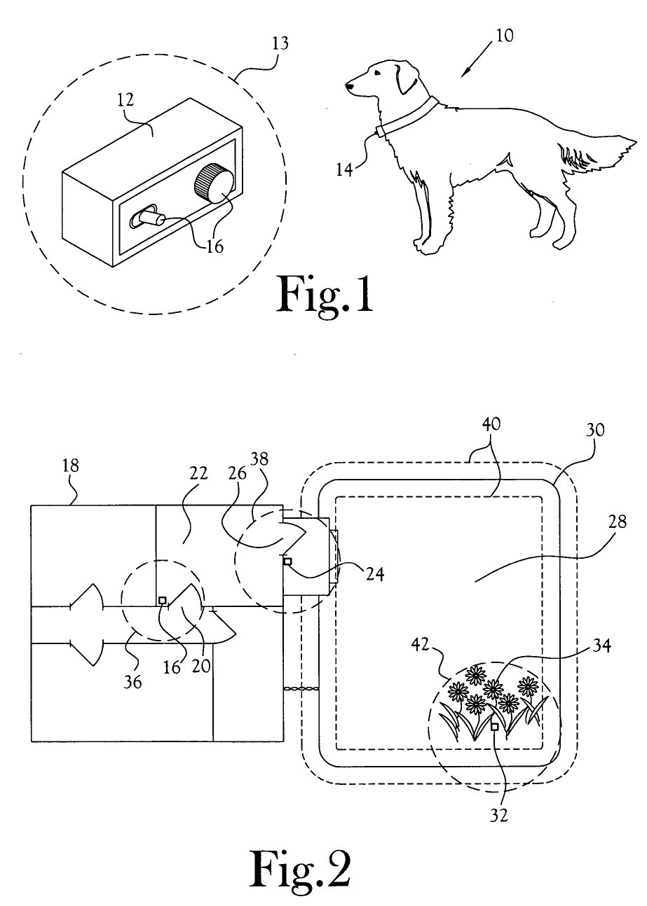

FIG. 2 is a diagram illustrating strategically positioned signal generating devices 12 to exemplify various features of the pet gate device 10. A first signal generating device 16 is disposed within a house 18. More specifically, the first signal generating device 16 is disposed proximate to an internal doorway 20 of the house 18. The internal doorway 20 is the passageway from a room 22 to the other rooms of the house 18. A second signal generating device 24 is disposed outside of the house 18 and proximate to an external doorway 26 of the house 18. The external doorway 26 is the passageway from the room 22, and consequently the house 18, to a yard 28. The yard 28 is adjacent to the house 18 and is defined by a conventional invisible pet containment system 30. A third signal generating device 32 is disposed within the yard 28. More specifically, the third signal generating device 32 is disposed proximate to a flower garden 34, which is located near the perimeter of the conventional invisible pet containment system 30.

The first signal generating device 16 generates and transmits the barrier signal, which generates a first electromagnetic field 36. The first electromagnetic field 36 radiates from the first signal generating device 16 to the extent that the coverage area of the first electromagnetic field 36 includes the internal doorway 20. Consequently, when the pet approaches the internal doorway 20 to the extent that the receiver 14 responds to the first electromagnetic field 36 and recognizes that the barrier signal is being generated and transmitted, the receiver 14 administers a stimulus to the pet. As a result, the first signal generating device 16 creates a non-tangible electrical barrier to the internal doorway 20. Consequently, the pet is confined within, or restricted from, the room 22.

The second signal generating device 24 generates and transmits the passageway signal, which generates a second electromagnetic field 38. Additionally, the conventional invisible pet containment system 30 generates and transmits the conventional signal, which generates a conventional electromagnetic field 40. The second electromagnetic field 38 radiates from the second signal generating device 24 to the extent that the coverage area of the second electromagnetic field 38 includes the section of the conventional electromagnetic field 40 that is between the house 18 and the yard 28 and that is proximate to the external doorway 26. Consequently, when the pet approaches the external doorway 26 from the yard 28 to the extent that the receiver 14 responds to both the second electromagnetic field 38 and the conventional electromagnetic field 40 and recognizes that both the passageway signal and the conventional signal are being generated and transmitted, the receiver 14 does not administer a stimulus to the pet. The receiver 14 does not administer a stimulus to the pet because the passageway signal overrides the conventional signal. Consequently, the second signal generating device 24 creates a non-tangible electrical passageway through the conventional invisible pet containment system 30 at the external doorway 26 such that the pet passes between the house 18 and the yard 28 without receiving a stimulus. Additionally, the non-tangible electrical passageway is created without compromising the designed function of the conventional invisible pet containment system 30, namely confining the pet to the yard 28.

The third signal generating device 32 generates and transmits the barrier signal, which generates a third electromagnetic field 42. The third electromagnetic field 42 radiates from the third signal generating device 32 to the extent that the coverage area of the third electromagnetic field 42 includes the flower garden 34. Consequently, when the pet approaches the flower garden 34 to the extent that the receiver 14 responds to the third electromagnetic field 42 and recognizes that the barrier signal is being generated and transmitted, the receiver 14 administers a stimulus to the pet. As a result, the third signal generating device 32 creates a non-tangible electrical barrier around the flower garden 34. Consequently, the pet is restricted from tampering with the flower garden 32.

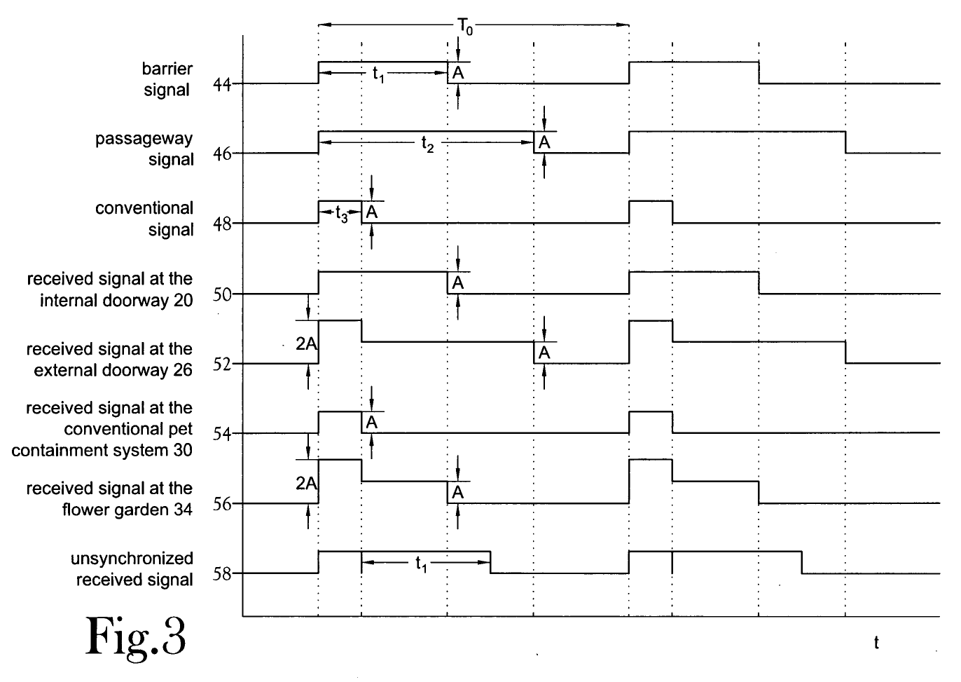

FIG. 3 is a timing diagram further illustrating previously discussed operative features of the receiver 14. In the illustrated embodiment, the barrier signal 44 is a periodic rectangular pulse signal with a pulse duration of t₁, a period of T₀, and an amplitude of A. The passageway signal 46 is a periodic rectangular pulse signal with a pulse duration of t₂, a period of T₀, and an amplitude of A. Further, the pulse duration of the passageway signal 46, t₂, is greater than the pulse duration of the barrier signal 44, t₁. The conventional signal 48 is a periodic rectangular pulse signal with a pulse duration of t₃, a period of T₀, and an amplitude of A. Further, the pulse duration of the conventional signal 48, t₃, is less than the pulse duration of the barrier signal 44, t₁, to the extent that the pulse duration of the conventional signal 48 and the pulse duration of the barrier signal 44 combined are less than the pulse duration of the passageway signal 46. In other words, t₁+t₃<t₂.

Those skilled in the art will recognize that the barrier signal, the passageway signal, and the conventional signal can be a signal other than a rectangular pulse signal without departing from the scope or spirit of the present invention. Additionally, those skilled in the art will recognize that the pulse duration relationship between the barrier signal, the passageway signal, and the conventional signal can be a relationship other than the pulse duration relationship of the illustrated embodiment without departing from the scope or spirit of the present invention.

The receiver 14 is adapted to recognize whether the barrier signal 44, the passageway signal 46, or the conventional signal 48 is being generated and transmitted. In the illustrated embodiment, the receiver 14 distinguishes the signals by monitoring the pulse duration of the received signal. For example, when the receiver 14 receives a signal with a pulse duration of t₁, the receiver 14 interprets that the barrier signal 44 is being generated and transmitted and administers a stimulus to the pet. Similarly, when the receiver 14 receives a signal with a pulse duration of t₃, the receiver 14 interprets that the conventional signal 48 is being generated and transmitted and administers a stimulus to the pet. Conversely, when the receiver 14 receives a signal with a pulse width of t₂, the receiver 14 determines that the passageway signal 46 is being generated and transmitted and does not administer a stimulus to the pet. More specifically, the receiver 14 is adapted to translate any signal with a pulse duration of t₂ or greater as a passageway signal 46. Additionally, the receiver 14 is adapted to translate any signal with a pulse duration of less than t₂, other than t₁ or t₃, as a stimulus-causing signal. Those skilled in the art will recognize that the receiver 14 can be adapted to recognize whether the barrier signal 44, the passageway signal 46, or the conventional signal 48 is being generated and transmitted by monitoring aspects of the received signal other than pulse duration, such as amplitude or frequency, without departing from the scope or spirit of the present invention.

Returning to FIG. 2, the first signal generating device 16 generates and transmits the barrier signal 44. Consequently, when the pet approaches the internal doorway 20 to the extent that the receiver 14 responds to the first electromagnetic field 36, the receiver 14 receives the signal illustrated at 50 in FIG. 3. The receiver 14 recognizes the received signal 50 as the barrier signal 44 because the received signal 50 has a pulse duration of t₁. Consequently, the receiver 14 administers a stimulus to the pet. As a result, the first signal generating device 16 creates a non-tangible electrical barrier in the internal doorway 20.

Returning to FIG. 2, the second signal generating device 24, generates and transmits the passageway signal 46. Additionally, the conventional invisible pet containment system 30 generates and transmits the conventional signal 48. Consequently, when the pet approaches the external doorway 26 from the yard 28 to the extent that the receiver 14 responds to both the second electromagnetic field 38 and the conventional electromagnetic field 40, the receiver 14 receives the signal illustrated at 52 in FIG. 3. The receiver 14 recognizes the received signal 52 as the passageway signal 46 because, although the received signal 52 has an amplitude of 2A for a pulse duration of t₃ and then an amplitude of A for a pulse duration of (t₂−t₃), the total pulse duration of the received signal 52 is t₂. Consequently, the receiver 14 does not administer a stimulus to the pet. The depiction of the received signal 52 illustrates how the passageway signal 46 overrides a stimulus-causing signal, such as the conventional signal 48 or the barrier signal 44. Thus, the second signal generating device 24 creates a non-tangible electrical passageway through the perimeter of the invisible pet containment system 30.

Returning to FIG. 2, the conventional invisible pet containment system 30 generates and transmits the conventional signal 48. Consequently, when the pet approaches the perimeter of the yard 28 to the extent that the receiver 14 responds to the conventional electromagnetic field 40, the receiver 14 receives the signal illustrated at 54 in FIG. 3. The receiver 14 recognizes the received signal 54 as the conventional signal 48 because the received signal 54 has a pulse duration of t₃. Consequently, the receiver 14 administers a stimulus to the pet. As a result, the invisible pet containment system 30 serves its designed conventional purpose, namely confining the pet within the yard 28.

Returning to FIG. 2, the third signal generating device 32 generates and transmits the barrier signal 44. Additionally, the conventional invisible pet containment system 30 generates and transmits the conventional signal 48. Consequently, when the pet approaches the flower garden 34 to the extent that the receiver 14 responds to both the third electromagnetic field 42 and the conventional electromagnetic field 40, the receiver 14 receives the signal illustrated at 56 in FIG. 3. The receiver 14 recognizes the received signal 56 as the barrier signal 44 because, although the received signal 56 has an amplitude of 2A for a pulse duration of t₃ and then an amplitude of A for a pulse duration of (t₁−t₃), the total pulse duration of the received signal 56 is t₁. Consequently the receiver 14 administers a stimulus to the pet. Thus, the third signal generating device 32 creates a non-tangible electrical barrier around the flower garden 34.

Sometimes, the signals received by the receiver 14 are not synchronized. In other words, when the receiver 14 recognizes more than one signal, the leading edges of the signals are not received simultaneously. For example, at the flower garden 34 of FIG. 2, where the third electromagnetic field 42 and the conventional electromagnetic field 40 overlap, the receiver 14 receives both the barrier signal 44, which is generated and transmitted by the third signal generating device 32, and the conventional signal 48, which is generated and transmitted by the invisible pet containment system 30. When the two received signals are unsynchronized, the resulting signal received by the receiver 14 is similar to the unsynchronized signal illustrated at 58 in FIG. 3. The receiver 14 recognizes the received signal 58 as a stimulus-causing signal because the received signal 58 has a pulse duration of (t₁+t₃). The received signal 58 is not mistakenly interpreted as a passageway signal 48 because, as previously discussed, t₁+t₃<t₂. Consequently, the receiver 14 administers a stimulus to the pet. Additionally, it is understood that an unsynchronized received signal that includes a passageway signal 46 is interpreted as a passageway signal 46, even when the pulse duration of the unsynchronized received signal is greater than t₂, because the receiver 14 interprets a received signal with a pulse duration of t₂ or greater as a passageway signal 46.

From the foregoing description, those skilled in the art will recognize that a device for generating an electrical pet gate offering advantages over the prior art has been provided. The device provides a non-tangible electrical pet barrier for doorways and small designated areas. Further, the device provides a non-tangible electrical pet passageway through a conventional invisible pet containment system.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, We claim:

1. A pet gate device for generating a non-tangible electrical barrier and a non-tangible electrical passageway, said pet gate device comprising:
a signal generating device for generating at least a barrier signal and a passageway signal, said signal generating device for transmitting the barrier signal and the passageway signal; and
a receiver for receiving the barrier signal and the passageway signal transmitted by said signal generating device, said receiver in communication with a conventional invisible pet containment system, said receiver carried by a pet, said receiver for administering a stimulus to the pet when said receiver receives the barrier signal and does not receive the passageway signal, said receiver for administering the stimulus to the pet when said receiver receives a conventional signal generated by a conventional invisible pet containment system and does not receive the passageway signal, said receiver for not administering the stimulus to the pet when said receiver receives the passageway signal.

2. The pet gate device of claim 1 wherein the stimulus is an electrostatic stimulus.

3. The pet gate device of claim 1 wherein said signal generating device generates and transmits a warning signal, said receiver administers a warning stimulus to the pet when said receiver receives the warning signal and does not receive the passageway signal.

4. The pet gate device of claim 3 wherein the warning stimulus is an audible stimulus.

5. The pet gate device of claim 3 wherein the warning stimulus is a visual stimulus.

6. The pet gate device of claim 1 wherein said signal generating device generates and transmits only one signal at a given time.

7. The pet gate device of claim 1 wherein the barrier signal is a rectangular pulse signal and the passageway signal is a rectangular pulse signal, the barrier signal having a pulse duration that is different from the pulse duration of the passageway signal.

8. The pet gate device of claim 7 wherein the barrier signal, the passageway signal, and the conventional signal have different pulse durations, said receiver recognizing the barrier signal, the passageway signal, and the conventional signal by considering the pulse duration of the received signal.

9. The pet gate device of claim 1 wherein the barrier signal, the passageway signal, and the conventional signal have different amplitudes, said receiver recognizing the barrier signal, the passageway signal, and the conventional signal by considering the amplitude of the received signal.

10. The pet gate device of claim 1 wherein the barrier signal, the passageway signal, and the conventional signal have different frequencies, said receiver recognizing the barrier signal, the passageway signal, and the conventional signal by considering the frequency of the received signal.

11. A pet gate device for generating a non-tangible electrical barrier and a non-tangible electrical passageway, said pet gate device comprising:
a signal generating device, said signal generating device adapted to generate at least a barrier signal and a passageway signal;
a transmitter, said transmitter in electrical communication with said signal generating device, said transmitter adapted to transmit the barrier signal and the passageway signal such that the transmitted signal generates an electromagnetic field;
a conventional invisible pet containment system, said conventional invisible pet containment system adapted to generate and transmit a conventional signal such that the transmitted conventional signal generates a conventional electromagnetic field; and
a receiver, said receiver carried by a pet, said receiver adapted to respond to the electromagnetic field, said receiver adapted to respond to the conventional electromagnetic field, said receiver adapted to administer a stimulus to the pet in response to recognizing the barrier signal and not recognizing the passageway signal, said receiver adapted to administer a stimulus to the pet in response to recognizing the conventional signal and not recognizing the passageway signal, said receiver adapted to not administer a stimulus to the pet in response to recognizing the passageway signal.

12. The pet gate device of claim 11 wherein said signal generating device is adapted to generate only one signal at a given time.

13. The pet gate device of claim 12 wherein said signal generating device includes a user interface, the user interface is adapted to permit a pet gate device user to adjust whether a barrier signal or a passageway signal is generated.

14. The pet gate device of claim 11 wherein said receiver is adapted to recognize whether said receiver received the barrier signal, the passageway signal, or the conventional signal by considering the pulse duration of the received signal.

15. The pet gate device of claim 11 wherein said receiver is adapted to recognize whether said receiver received the barrier signal, the passageway signal, or the conventional signal by considering the amplitude of the received signal.

16. The pet gate device of claim 11 wherein said receiver is adapted to recognize whether said receiver received the barrier signal, the passageway signal, or the conventional signal by considering the frequency of the received signal.

17. A pet gate device for generating a non-tangible electrical barrier and a non-tangible electrical passageway, said pet gate device comprising:
a signal generating device, said signal generating device generating and transmitting a passageway signal; and
a receiver, said receiver in wireless communication with said signal generating device, said receiver in wireless communication with a conventional invisible pet containment system, said receiver carried by a pet, said receiver administering a stimulus to the pet when said receiver receives a signal from the conventional invisible pet containment system and does not concurrently receive the passageway signal from said signal generating device, said receiver not administering a stimulus to the pet when said receiver receives the passageway signal from said signal generating device.

18. The pet gate system of claim 17 wherein said signal generating device generates and transmits a barrier signal, said receiver administering a stimulus to the pet when said receiver receives the barrier signal and does not concurrently receive the passageway signal.
